(19) United States
(12) Patent Application Publication
(10) Pub. No.: US 2011/0204163 A1
(43) Pub. Date: Aug. 25, 2011

(54) Insulation system

(76) Inventor: James Douglas Gleadall, Coldwater (CA)

(21) Appl. No.: 13/014,598

(22) Filed: Jan. 26, 2011

Related U.S. Application Data
(60) Provisional application No. 61/299,248, filed on Jan. 28, 2010.

(51) Int. Cl. B05B 3/00

(52) U.S. Cl. 239/722

(57) ABSTRACT

The present invention is an insulation system that is installed on a boom pipe and a boom pipe nozzle or a dispersion hose of a concrete pump to prevent concrete from freezing or setting while being poured. The system includes a boom pipe covering with two vinyl canvas exterior sheets with a layer of reflective foil insulation held together with a first hook and loop fastener, a dispersion nozzle covering with two vinyl canvas exterior sheets with a layer of reflective foil insulation held together with a second hook and loop fastener and a dispersion hose covering with two vinyl canvas exterior sheets with a layer of reflective foil insulation with a flexible orifice perimeter to insulate said dispersion hose.

This application claims priority to U.S. Provisional Application 61/299,248 filed on Jan. 28, 2010, the entire disclosure of which is incorporated by reference.

### TECHNICAL FIELD & BACKGROUND

The present invention generally relates to an insulation system. More specifically, the invention is an insulation system that is installed on a boom pipe of a concrete pump.

It is an object of the invention to provide an insulation system that is installed on a boom pipe of a concrete pump that reduces labor costs for installing insulation on concrete pump boom systems as well as the yearly material costs of insulating concrete pump boom systems.

It is an object of the invention to provide an insulation system that is installed on a boom pipe of a concrete pump that is reusable and that requires only one person to install instead of 2 or 3 people.

It is an object of the invention to provide an insulation system that is installed on a boom pipe of a concrete pump that is reusable to reduce material costs of buying insulation and disposal costs.

It is an object of the invention to provide an insulation system that can be used in hot or cold climates.

What is really needed is an insulation system that is installed on a boom pipe of a concrete pump that reduces labor costs for installing insulation on concrete pump boom systems as well as the yearly material costs of insulating concrete pump boom systems, that requires only one person to install instead of 2 or 3 people, that is reusable to reduce material costs of buying insulation and disposal costs and that can be used in hot or cold climates.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates a front perspective view of the components of an insulation system installed on a boom pipe of a concrete pump, in accordance with one embodiment of the present invention.

FIG. 1B illustrates a front perspective view of a boom pipe covering of an insulation system installed on a boom pipe of a concrete pump, in accordance with one embodiment of the present invention.

FIG. 1C illustrates a front overhead perspective view of a dispersion nozzle covering of an insulation system installed on a boom pipe nozzle of a boom pipe of a concrete pump, in accordance with one embodiment of the present invention.

FIG. 1D illustrates a side perspective view of a dispersion hose of an insulation system installed on a boom pipe of a concrete pump, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

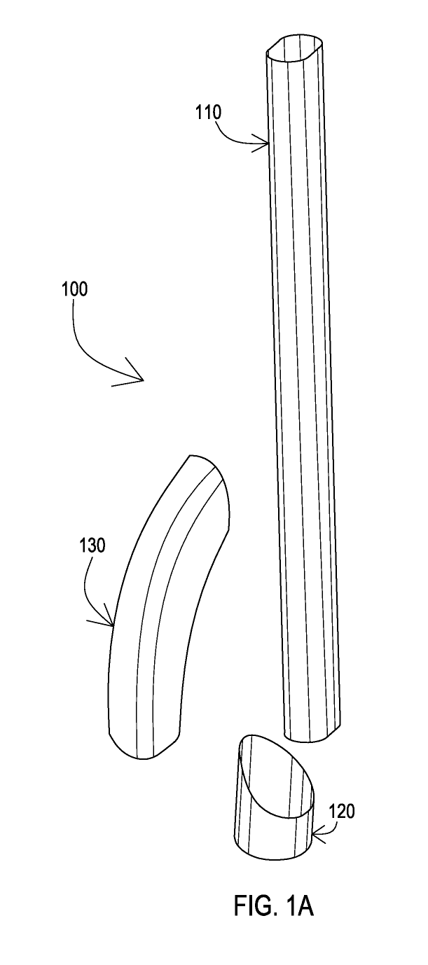

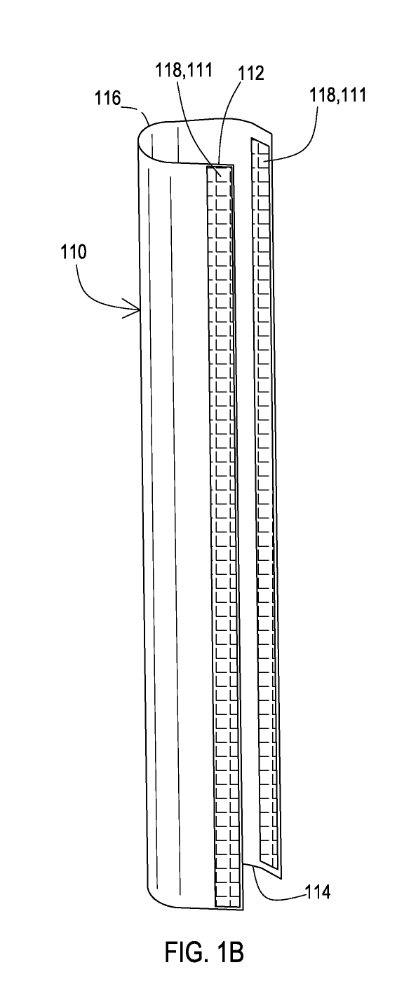

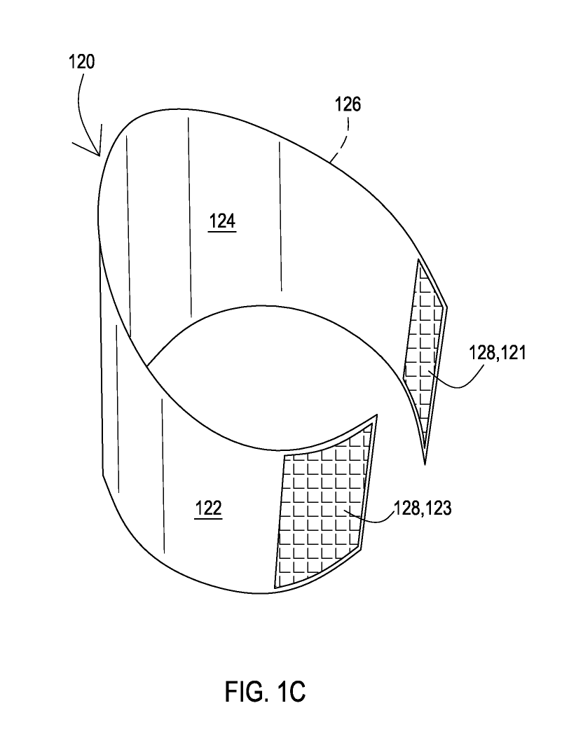

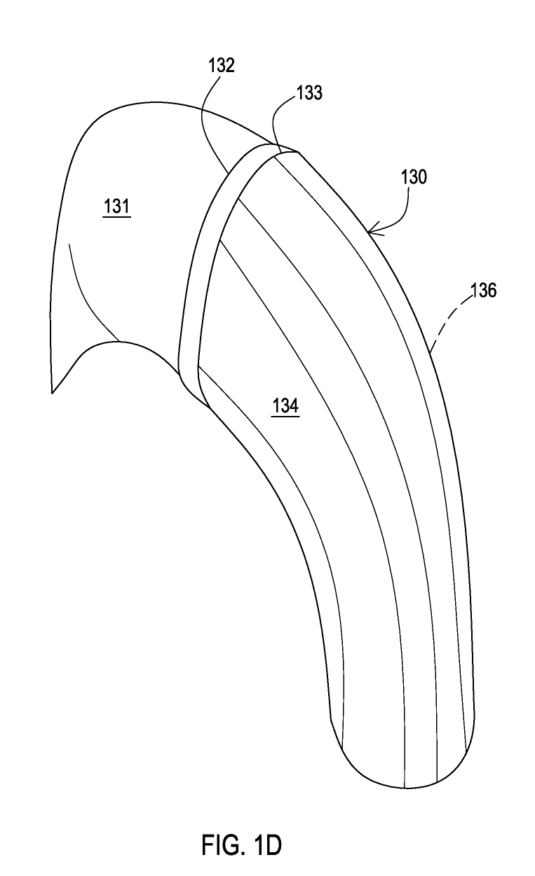

FIG. 1A illustrates a front perspective view of the components of an insulation system 100 installed on a boom pipe of a concrete pump, in accordance with one embodiment of the present invention. Concrete pump contractors in colder climates insulate their boom pipe to prevent the concrete from freezing or setting while it is being poured. The insulation system 100 is designed for insulating concrete pump components to prevent the concrete in the boom pipe from freezing or setting. The insulation system 100 installed on a boom pipe of a concrete pump's components include a boom pipe covering 110, a dispersion nozzle covering 120 and a dispersion hose covering 130. The boom pipe covering 110 can be used in combination with the dispersion nozzle covering 120 to disperse insulation installed on a boom pipe of a concrete pump (not shown) and can covers any portion of a boom system such as any elbows, associated hoses or standpipes that might be part of any high rise work. Details regarding the boom pipe covering 110 are described further in FIG. 1B and its description and details regarding the dispersion nozzle covering 120 are described in FIG. 1C and its description. The dispersion hose covering 130 is made of flexible material and is attached to a dispersion nozzle of a concrete pump (see FIG. 1D) and is described further in FIG. 1D and its description.

FIG. 1B illustrates a front perspective view of an boom pipe covering 110 of an insulation system 100 installed on a boom pipe (not shown) of a concrete pump, in accordance with one embodiment of the present invention. The boom pipe covering 110 includes two exterior sheets 112,114 that are typically made of vinyl canvas, although the two exterior sheets 112,114 can be made of any suitable material, with a layer of reflective foil insulation 116 disposed between the two vinyl canvas sheets 112,114. The boom pipe covering 110 is cut to the circumference and length of the concrete pump boom pipe. The boom pipe covering 110 is held together with an elongated hook and loop type Velcro fastener 118 that is attached on the edge 111 of the boom pipe covering 110. Any shape or number of hook and loop type fasteners can be utilized with the boom pipe covering 110 to secure the boom type covering 110 around the boom pipe of a concrete pump.

FIG. 1C illustrates a front overhead perspective view of a dispersion nozzle covering 120 of an insulation system 100 installed on a boom pipe nozzle (not shown) of a boom pipe of a concrete pump, in accordance with one embodiment of the present invention. The dispersion nozzle covering 120 includes two exterior sheets 122,124 that are typically made of vinyl canvas, although the two exterior sheets 122,124 can be made of any suitable material, with a layer of reflective foil insulation 126 disposed between the two vinyl canvas sheets 122,124. The dispersion nozzle covering 120 is cut to the circumference and length of a boom pipe nozzle disposed on the end of a boom pipe of a concrete pump. The dispersion nozzle covering 120 is held together with a hook and loop type Velcro fastener 128 that is attached on the ends 121,123 of the dispersion nozzle covering 120. Any shape or number of hook and loop type fasteners can be utilized with the dispersion nozzle covering 120 to secure the dispersion nozzle covering 120 around the boom pipe nozzle of a concrete pump.

FIG. 1D illustrates a side perspective view of a dispersion hose covering 130 of an insulation system 100 installed on a dispersion hose (not shown) of a concrete pump, in accordance with one embodiment of the present invention. The dispersion hose covering 130 is made of relatively very flexible material that can be placed over a dispersion hose from a concrete pump. The dispersion hose covering 130 includes two exterior sheets 132,144 that are typically made of vinyl canvas, although the two exterior sheets 132,134 can be made of any suitable material, with a layer of reflective foil insulation 136 disposed between the two vinyl canvas sheets 132,134. The dispersion hose covering 130 is cut to the circumference and length of a dispersion hose disposed on the end of a boom pipe of a concrete pump and is not used in combination with the boom pipe covering 110 and dispersion nozzle covering 120. The dispersion hose covering 130 includes a flexible proximal orifice perimeter 133 that can be pulled-up snuggly to fit on a dispersion nozzle 131 disposed on the end of a boom pipe of a concrete pump.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An insulation system that is installed on a boom pipe and a boom pipe nozzle or a dispersion hose of a concrete pump, comprising:
a boom pipe covering that includes a first set of two exterior sheets with a first layer of insulation disposed between said first exterior sheets to insulate said boom pipe;
a dispersion nozzle covering that includes a second set of two exterior sheets with a second layer of insulation disposed between said second exterior sheets to insulate said boom pipe nozzle; and
a dispersion hose covering that includes a third set of two exterior sheets with a third layer of insulation disposed between said third exterior sheets with a flexible orifice perimeter to insulate said dispersion hose.

2. The system according to claim 1, wherein said first set of exterior sheets are made of vinyl canvas.

3. The system according to claim 1, wherein said first layer of insulation is made of reflective foil insulation.

4. The system according to claim 1, wherein said boom pipe covering is held together with a first hook and loop fastener.

5. The system according to claim 4, wherein said first hook and loop fastener is elongated and attached on an edge of said boom pipe covering.

6. The system according to claim 1, wherein said second exterior sheets are made of vinyl canvas.

7. The system according to claim 1, wherein said second layer of insulation is made of reflective foil insulation.

8. The system according to claim 1, wherein said dispersion nozzle covering is held together with a second hook and loop fastener.

9. The system according to claim 8, wherein sad second hook and loop fastener is disposed on both ends of said dispersion nozzle covering.

10. The system according to claim 1, wherein said third set of exterior sheets are made of vinyl canvas.

11. The system according to claim 1, wherein said third layer of insulation is made of reflective foil insulation.

12. The system according to claim 1, wherein said flexible orifice perimeter can be pulled-up snuggly to fit on a dispersion nozzle of said pump.

13. The system according to claim 1, wherein said boom pipe covering, said dispersion nozzle covering and said dispersion hose covering can cover any portion of a boom system including any elbows, associated hoses or standpipes that might be part of any high rise work.

14. The system according to claim 1, wherein said insulation system prevents concrete from freezing or setting while being poured.

15. An insulation system that is installed on a boom pipe and a boom pipe nozzle or a dispersion hose of a concrete pump to prevent concrete from freezing or setting while being poured, comprising:
a boom pipe covering that includes a first set of two vinyl canvas exterior sheets with a first layer of reflective foil insulation disposed between said first exterior sheets to insulate said boom pipe with said boom pipe covering is held together with a first hook and loop fastener;
a dispersion nozzle covering that includes a second set of two vinyl canvas exterior sheets with a second layer of reflective foil insulation disposed between said second exterior sheets to insulate said boom pipe nozzle, where said dispersion nozzle covering is held together with a second hook and loop fastener; and
a dispersion hose covering that includes a third set of two vinyl canvas exterior sheets with a third layer of reflective foil insulation disposed between said third exterior sheets with a flexible orifice perimeter to insulate said dispersion hose, said boom pipe covering, said dispersion nozzle covering and said dispersion hose covering can cover any portion of a boom system including any elbows, associated hoses or standpipes that might be part of any high rise work.

16. The system according to claim 15, wherein said first hook and loop fastener is elongated and attached on an edge of said boom pipe covering.

17. The system according to claim 15, wherein said second hook and loop fastener is disposed on both ends of said dispersion nozzle covering.

18. The system according to claim 15, wherein said flexible orifice perimeter can be pulled-up snuggly to fit on a dispersion nozzle of said pump.

19. An insulation system that is installed on a boom pipe and a boom pipe nozzle or a dispersion hose of a concrete pump to prevent concrete from freezing or setting while being poured, comprising:
a boom pipe covering that includes a first set of two vinyl canvas exterior sheets with a first layer of reflective foil insulation disposed between said first exterior sheets to insulate said boom pipe with said boom pipe covering is held together with a first hook and loop fastener that is elongated and attached on an edge of said boom pipe covering;
a dispersion nozzle covering that includes a second set of two vinyl canvas exterior sheets with a second layer of reflective foil insulation disposed between said second exterior sheets to insulate said boom pipe nozzle, where said dispersion nozzle covering is held together with a second hook and loop fastener that is disposed on both ends of said dispersion nozzle covering; and
a dispersion hose covering that includes a third set of two vinyl canvas exterior sheets with a third layer of reflective foil insulation disposed between said third exterior sheets with a flexible orifice perimeter to insulate said dispersion hose, said boom pipe covering, said dispersion nozzle covering and said dispersion hose covering can cover any portion of a boom system including any elbows, associated hoses or standpipes that might be part of any high rise work.

20. The system according to claim 19, wherein said flexible orifice perimeter can be pulled-up snuggly to fit on a dispersion nozzle of said pump.
